(19) United States
(12) Patent Application Publication
(10) Pub. No.: US 2012/0140249 A1
(43) Pub. Date: Jun. 7, 2012

(54) INFORMATION PROCESSING DEVICE, INFORMATION PROCESSING METHOD, AND COMPUTER PROGRAM PRODUCT

(76) Inventor: Daisuke TAMASHIMA, Kanagawa (JP)

(21) Appl. No.: 13/306,148

(22) Filed: Nov. 29, 2011

(30) Foreign Application Priority Data
Dec. 3, 2010 (JP) 2010-270728

(51) Int. Cl. G06K 15/02

(52) U.S. Cl. 358/1.2; 358/1.13

(57) ABSTRACT

An information processing device includes a first generating unit that generates a first command for instructing to paint out a character string; a first transmitting unit that transmits the first command to a printer driver; a second generating unit that, when receiving the first command, generates a second command for instructing to output the character string in a mask pattern, the mask pattern being made of a painted out part of the character string and a transparent part of the character string; and a second transmitting unit that transmits the first command and the second command.

### CROSS-REFERENCE TO RELATED APPLICATIONS

The present application claims priority to and incorporates by reference the entire contents of Japanese Patent Application No. 2010-270728 filed in Japan on Dec. 3, 2010.

### BACKGROUND OF THE INVENTION

1. Field of the Invention

The present invention relates to an information processing device, an information processing method and a computer program product.

2. Description of the Related Art

In the related art, printer drivers have been known to have a watermark function of adding character data (“Confidential” or the like), graphic data, or image data to data printed by an application.

In general, when an information processing device which uses a page description language such as a PostScript realizes a watermark function, the information processing device sends a printer a command to print watermark. This command includes information on the font and the character string to be added as the watermark. The printer receives the command from the information processing device and rasterizes the watermark using a font installed therein to print the watermark with a device font.

However, in the related art, it was difficult to implement the watermark function with a device font unless the device font is installed in the printer. For example, when an information processing device sends a command to add a watermark with a font C to a printer which does not support the font C, the printer is not able to add the watermark.

As a method of solving this problem, a method of adding a watermark using a TrueType font which is one of the outline font systems installed as a function of an operating system (OS) of personal computers (PC) has been used.

However, although the PostScript can cause an OS to draw an image using the TrueType font of the PC and can send rasterized data, it is difficult to make the data transparent using the raster operation, since it does not support a raster operation. The raster operation is a pixel operation of comparing a drawing color (source) with a drawn color (destination) pixel by pixel when drawing, and of executing a drawing command based on the comparison result.

For example, Japanese Patent Application Laid-open No. 2002-333959 discloses a print system which includes a printer driver capable of implementing a watermark function for the purpose of enabling a printer, which does not have a built-in font and does not support a watermark command, to print marks or patterns which include a watermark. The printer driver of Japanese Patent Application Laid-open No. 2002-333959 designates bitmap data of a ground pattern to be printed on a sheet in advance, generates bitmap data of any image to be printed in an overlapped manner on the sheet having the ground pattern, and supplies the generated bitmap data to a printer so as to be superimposed on the print data.

However, although the method of Japanese Patent Application Laid-open No. 2002-333959 can generate new bitmap data, which makes a watermark appear transparently, on the print data, a printer driver which uses a function such as a mini-driver provided by an OS cannot add a watermark using the TrueType font of the PC so as to appear the watermark on the print data in a transparent manner.

### SUMMARY OF THE INVENTION

It is an object of the present invention to at least partially solve the problems in the conventional technology.

An information processing device includes: a first generating unit that generates a first command for instructing to paint out a character string, the character string being made of a character font stored in the device and being added to a print data; a first transmitting unit that transmits the first command to a printer driver; a second generating unit that, when receiving the first command, generates a second command for instructing to output the character string in a mask pattern, the mask pattern being made of a painted out part of the character string and a transparent part of the character string, the transparent part being not painted out for making the print data visible through the mask pattern; and a second transmitting unit that transmits the first command and the second command.

An information processing method includes: generating a first command for instructing to paint out a character string, the character string being made of a character font stored in the computer and being added to the print data; and transmitting the first command to a printer driver; when receiving the first command, generating a second command for instructing to output the character string in a mask pattern, the mask pattern being made of a painted out part of the character string and a transparent part of the character string, the transparent part being not painted out for making the print data visible through the mask pattern; and transmitting the first command and the second command.

A computer program product includes a non-transitory computer-readable medium having computer-readable program codes embodied in the medium, the program codes when executed causing a computer to function as: a drawing processor; and a process controller for processing print data. The process controller includes: a first generating unit that generates a first command for instructing to paint out a character string, the character string being made of a character font stored in the computer and being added to the print data; and a first transmitting unit that transmits the first command to the drawing processor. The drawing processor includes: a second generating unit that, when receiving the first command, generates a second command for instructing to output the character string in a mask pattern, the mask pattern being made of a painted out part of the character string and a transparent part of the character string, the transparent part being not painted out for making the print data visible through the mask pattern; and a second transmitting unit that transmits the first command and the second command.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a general configuration diagram of a print system to which an information processing device according to the present embodiment is connected;

FIG. 2A is a diagram illustrating an example of the output result of a watermark by a printer;

FIG. 2B is a diagram illustrating an example of the output result of a watermark by a printer;

FIG. 3 is a diagram illustrating the operation flow of Windows (registered trademark) print architecture;

FIG. 4 is a block diagram illustrating the configuration of a PC;

FIG. 5 is a functional block diagram of a print processor;

FIG. 6 is a functional block diagram of a printer driver;

FIG. 7 is a flowchart illustrating the flow of a print command transmission process by the PC;

FIG. 8 is a diagram illustrating an example of a user interface for setting a transparent pattern;

FIG. 9 is a diagram illustrating an example of a command sent from the print processor to a GDI;

FIG. 10 is a diagram illustrating painted out parts and the transparent part of a character string as a watermark;

FIG. 11 is a diagram illustrating a command for a mask pattern generated by the printer driver;

FIG. 12 is a diagram illustrating an example of the printed result by the printer;

FIG. 13 is a diagram illustrating painted out parts determined by the printer driver;

FIG. 14 is a diagram illustrating a command for a mask pattern generated by the printer driver;

FIG. 15 is a diagram illustrating an example of the printed result by the printer;

FIG. 16 is a diagram illustrating painted out parts determined by the printer driver;

FIG. 17 is a diagram illustrating a command for a mask pattern generated by the printer driver; and

FIG. 18 is a diagram illustrating a hardware configuration of the information processing device according to the present embodiment.

### DETAILED DESCRIPTION OF THE PREFERRED EMBODIMENTS

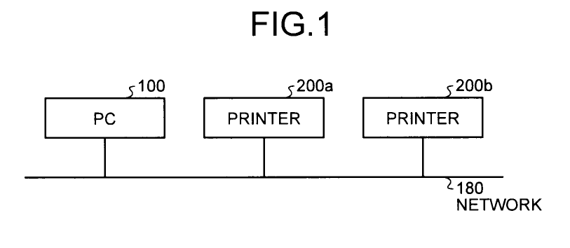

First, the general configuration of a print system to which an information processing device according to the present embodiment is connected will be described. FIG. 1 is an overall configuration diagram of a print system to which an information processing device according to a first embodiment of the present invention is connected. As illustrated in FIG. 1, in the print system, a personal computer (PC) 100 serving as the information processing device is connected to printers 200a and 200b (hereinafter collectively referred to as a printer 200) through a network 180.

The PC 100 receives a command to add drawing data to print data from a user, generates the drawing data in accordance with the command, transmits a print command to the printer 200 with the print data and the generated drawing data together, and cause the printer 200 to perform printing.

When the printer 200 receives the print command to add the drawing data to the print data from the PC 100, the printer 200 performs printing with the print data and the drawing data in accordance with the print command from the PC 100.

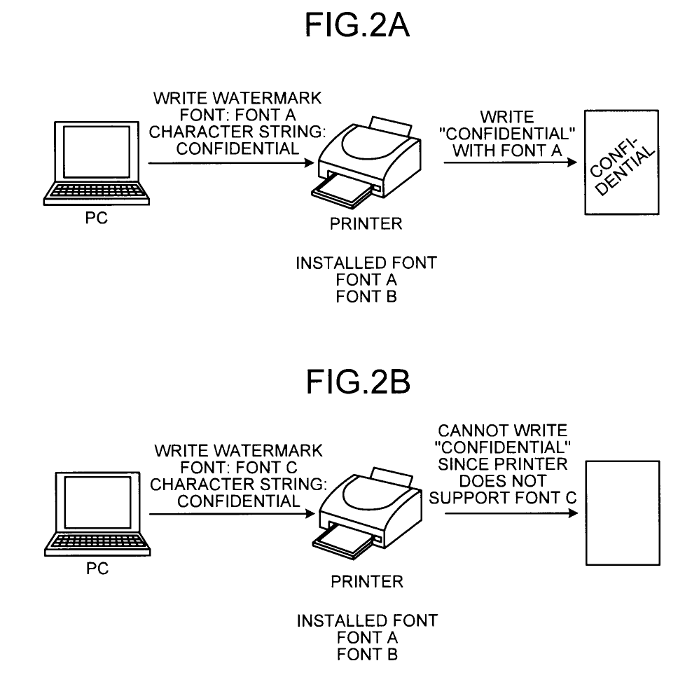

Next, an example of the related art will be described in which a watermark is printed using a device font. FIGS. 2A and 2B are diagrams illustrating an example of a watermark that is output by a printer. As illustrated in FIG. 2A, a PC instructs a printer to write a character string “Confidential” as a watermark using a font A. Since the printer has built-in fonts A and B, the printer can print the character string “Confidential” using the font A in accordance with the instruction from the PC.

On the other hand, in FIG. 2B, a PC instructs a printer to write a character string “Confidential” as a watermark using a font C. The printer has only fonts A and B therein and does not support the font C. Thus, the printer cannot print the watermark using the font C. As above, in the related art, when printing a watermark using a device font, a watermark in a font which is not installed in the printer cannot be printed.

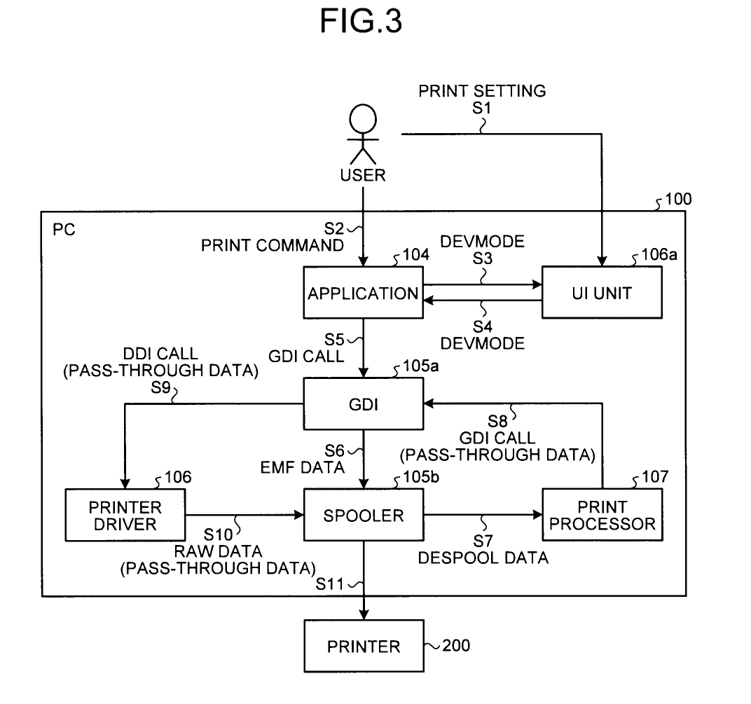

Next, the present embodiment which solves the problem of the related art will be described. FIG. 3 illustrates the outline of the flow of a print operation by the PC 100 using Windows (registered trademark) print architecture. FIG. 3 is a diagram illustrating the operation flow of the Windows (registered trademark) print architecture. As illustrated in FIG. 3, the PC 100 includes a UI unit 106a of a printer driver that receives a print setting from a user, an application 104 that receives a print command from the user, a GDI 105a that converts a received GDI call into EMF data or a DDI call to transfer the same to a spooler 105b or a printer driver 106, and the printer driver 106 that converts the language format of data, the spooler 105b that stores print data, and a print processor 107 that edits the print data received from the spooler 105b. The PC 100 is connected to the printer 200. The details of the functions and configurations of the respective units will be described later.

First, the UI unit 106a receives a changed printing setting from the user (step S1). For example, the UI unit 106a receives a watermark print setting for a watermark to be added to print data. The watermark print setting includes a designation of a mask pattern that masks part of the print data. Moreover, the mask pattern is made up of the resolution of the print data, a designated character string, and a transparent pattern. The character string is a collection of characters represented in a font installed in the PC 100. The transparent pattern is a pattern made of the painted out part and the transparent part. At the painted out part, the character string is painted out. At the transparent part, the character string is not painted out so that the underlying print data can be viewed.

The application 104 receives the print command from the user (step S2). The application 104 receives the print setting from the user by exchanging data with the UI unit 106a and a structure called DEVMODE which has a print setting therein (steps S3 and S4). In this case, the application 104 receives a designation of print data which is to be printed, and the print setting together. The print data is the data in the enhanced metafile format (EMF) created in the course of processing by the application 104. The conversion from the GDI call sent from the print processor 107 into the DDI call is executed in a spool process by the spooler 105b.

The application 104 delivers the print command of the print data to the GDI 105a using a graphic device interface (GDI) call (step S5). The GDI 105a delivers print data of the EMF format to the spooler 105b as spool data (step S6). The spooler 105b finishes spooling the entire print data created by the application 104, then transmits a notice to the print processor 107 to despool the print data and then despools the print data to the print processor 107 (step S7).

The print processor 107 reads the print data received from the spooler 105b, edits the print data page by page, and delivers the edited content to the GDI 105a using a GDI call (step S8). In this case, the print processor 107 draws an image based on the print data on a device context in accordance with the print setting received by the UI unit 106a and edits the drawn device context.

The GDI 105a delivers the GDI call received from the print processor 107 to the printer driver 106 using a device driver interface (DDI) call which includes pass-through data (step S9). The pass-through data included in the DDI call is an instruction to output the mask pattern to the printer 200 and may be an identifier or the like.

Once receiving the DDI call including the pass-through data received from the GDI 105a, the printer driver 106 converts the print data of the EMF format which is the subject of the print command into a RAW format and transmits the RAW data to the spooler 105b (step S10).

The spooler 105b transmits the RAW data including the pass-through data received from the printer driver 106 to the printer 200 (step S11).

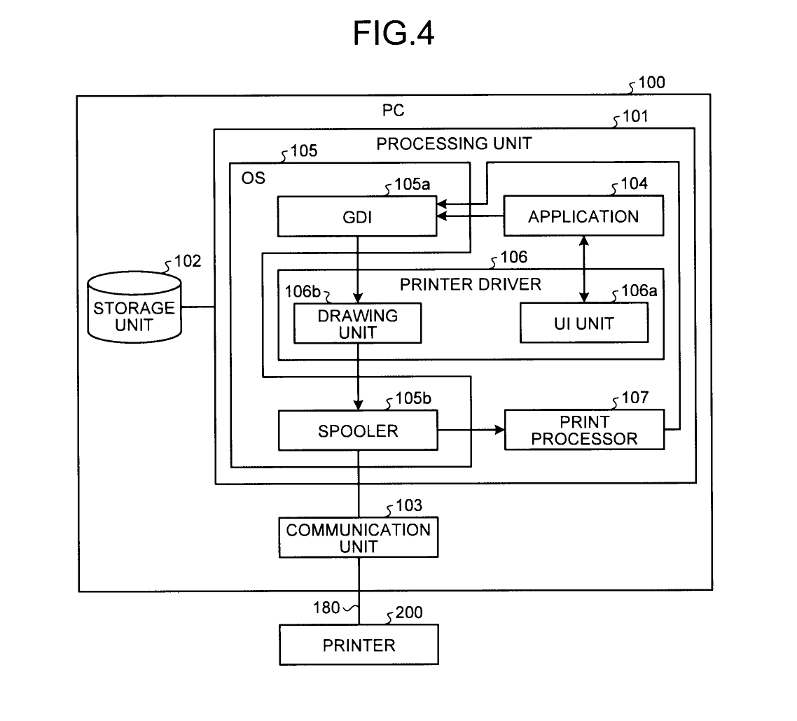

FIG. 4 is a block diagram illustrating the configuration of the PC 100. As illustrated in FIG. 4, the PC 100 includes a processing unit 101, a storage unit 102, and a communication unit 103. The processing unit 101 is configured to include a central processing unit (CPU) serving as a control means (not illustrated) and a group of memories including a ROM, and a RAM which serves as a main memory. When the PC 100 is started to operate, the application 104, an OS 105, various drivers (in FIG. 4, only the printer driver 106 is illustrated), and the print processor 107 are loaded and expanded onto a main memory from the ROM and the storage unit 102, and are executed by the CPU.

The PC 100 has a hardware configuration using a general computer which includes an input device such as a keyboard and/or a mouse and an output device such as a display, which are not illustrated in FIG. 4 in order to simplify the description.

The functional blocks (described later) in the processing unit 101 illustrated in FIG. 4 are functions or means which serve as the main unit for realizing print control of the printer 200.

The storage unit 102 is a storage means which stores various kinds of information. An HDD is a specific example thereof. The information stored in the storage unit 102 includes setting information which defines information (all kinds of information necessary for processing, such as setting values used for processing or display information for changing the setting values) regarding processing to realize the function of the printer driver 106.

The communication unit 103 is a network I/F that transmits and receives information to and from the printer 200 connected through the network 180.

The application 104 is assumed to be software (for example, a word processor) that enables a user to output a print command. In a case that the user wants to print data edited with the application 104, the application 104 receives a print command from the user. In this case, the application 104 does not generate print data to be used by the printer 200 by itself but rather delivers the information of a print subject to the GDI 105a and the UI unit (the printer driver) 106a along with a print request corresponding to the print command as DEVMODE. For example, the application 104 delivers the print data to the GDI 105a of the OS 105 using a graphics device interface (GDI) call.

The OS 105 is a program that controls the hardware and software of the PC 100. The OS 105 controls the startup of programs and the reading and storing of information. MS Windows (registered trademark) is a representative example of the OS. Moreover, the GDI 105a of the OS 105 delivers print subject information (text data, graphics data, image data, and the like) to the printer driver 106 through a device driver interface (DDI) call together with the print request including the setting information delivered from the application 104 through the GDI call. The print data generated by the printer driver 106 is stored sequentially in the spooler 105b and is delivered to the printer 200 through the communication unit 103.

The print processor 107 has the function of a processing control unit that processes the print data and receives the spooled print data from the spooler 105b. Moreover, the print processor 107 generates drawing data to be added to the print data in accordance with the user instruction received by the application 104.

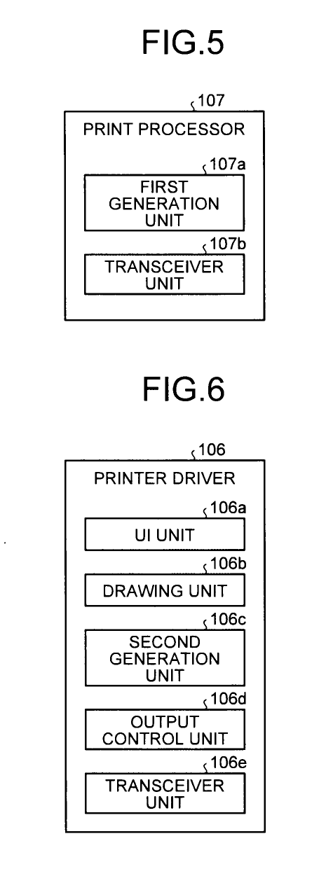

FIG. 5 is a functional block diagram of the print processor 107. As illustrated in FIG. 5, the print processor 107 includes a first generation unit 107a and a transceiver unit 107b.

The first generation unit 107a generates a paint-out command in accordance with the instruction of the watermark print setting received by the UI unit 106a. The paint-out command is a command to paint out the character string that makes up the mask pattern.

The transceiver unit 107b has the function of a first transmitting unit which transmits the paint-out command generated by the first generation unit 107a to the printer driver 106 through the GDI 105a. The transceiver unit 107a transmits and receives various kinds of information to and from the printer driver 106 and the GDI 105a.

Next, the details of the printer driver 106 will be described with reference to FIG. 6. FIG. 6 is a functional block diagram of the printer driver 106. As illustrated in FIG. 6, the printer driver 106 has the function of a drawing processor, and includes the UI unit 106a, a drawing unit 106b, a second generation unit 106c, an output control unit 106d, and a transceiver unit 106e.

The UI unit 106a controls the user interface (UI) which receives the print settings input by the user. For example, the UI unit 106a receives the print setting (resolution, a character string, and a transparent pattern) of the watermark to be added to the print data. The UI unit 106a transmits the received print setting to the print processor 107 through the GDI 105a.

The second generation unit 106c converts the print data created by the application 104 into a format that can be understood by the printer. For example, the drawing unit 106b converts the print data created in the EMF format by the application 104 into a RAW format.

Moreover, once the paint-out command is received from the print processor 107 through the GDI 105a, the second generation unit 106c generates a PostScript command for the mask pattern. The PostScript command for the mask pattern is a command written in PostScript for outputting the mask pattern based on the painted out part and the transparent part, which are included therein. For example, the second generation unit 106c determines the painted out part and the transparent part on the basis of the resolution, the character string, and the transparent pattern of the print data received by the UI unit 106a and uses the determined painted out part and transparent part as the PostScript command for the mask pattern.

The output control unit 106d transmits the PostScript command of the mask pattern generated by the second generation unit 106c to the printer 200 through the transceiver unit 106e and outputs the mask pattern so as to be added to the print data transmitted to the printer 200.

The transceiver unit 106e receives the paint-out command from the print processor 107 through the GDI 105a. Moreover, the transceiver unit 106e transmits and receives various kinds of information to and from the GDI 105a, the print processor 107, the spooler 105b, the printer 200, and the like.

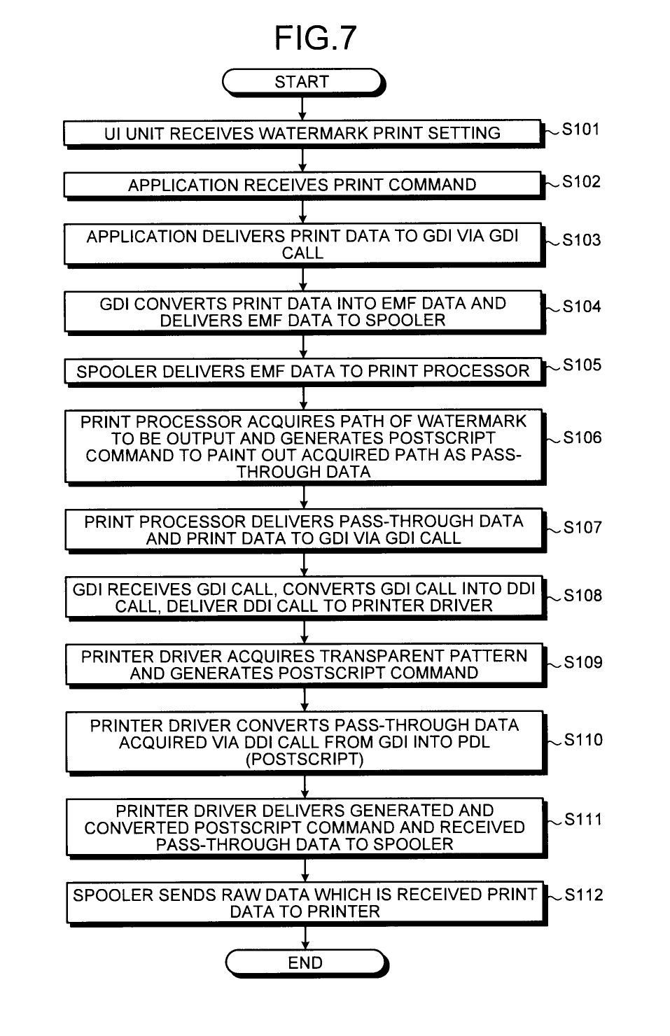

Next, an explanation will be made on a flow of a print command transmission process for transmitting the print command to the printer 200 from the PC 100 having the above-mentioned configuration. FIG. 7 is a flowchart illustrating the flow of the print command transmission process by the PC 100.

The UI unit 106a receives a watermark print setting from the user (step S101). In this case, the UI unit 106a receives a designation of the resolution of the print data, the character string, and the transparent pattern of the print data as the watermark print setting. The application 104 receives a print command from the user (step S102). In this case, the application 104 delivers DEVMODE to the GDI 105a and the UI unit 106a.

The application 104 delivers the print data including the watermark print setting to the GDI 105a through a GDI call (step S103).

The GDI 105a receives the print data including the print setting through the GDI call from the application 104, converts the print data into EMF data, and delivers the converted EMF data to the spooler 105b (step S104).

The spooler 105b delivers the EMF data to the print processor 107 (step S105). The print processor 107 acquires a path of a character string to be output as watermark and generates a PostScript command to paint out the acquired path of the character string as pass-through data (step S106).

The print processor 107 delivers the pass-through data and the print data including the print setting to the GDI 105a through a GDI call (step S107). Upon receiving the GDI call, the GDI 105a converts the received GDI call into a DDI call and delivers the DDI call to the printer driver 106 (step S108).

The printer driver 106 acquires a designated transparent pattern and generates a PostScript command (step S109). In this case, the printer driver 106 generates a PostScript command including a painted out part and a transparent part.

The printer driver 106 converts the pass-through data received through the DDI call from the GDI 105a into PDL (page description language, PostScript in this case) (step S110).

The printer driver 106 delivers the generated and converted PostScript command and the received pass-through data to the spooler 105b (step S111). The spooler 105b transmits RAW data which is the received print data to the printer 200 (step S112).

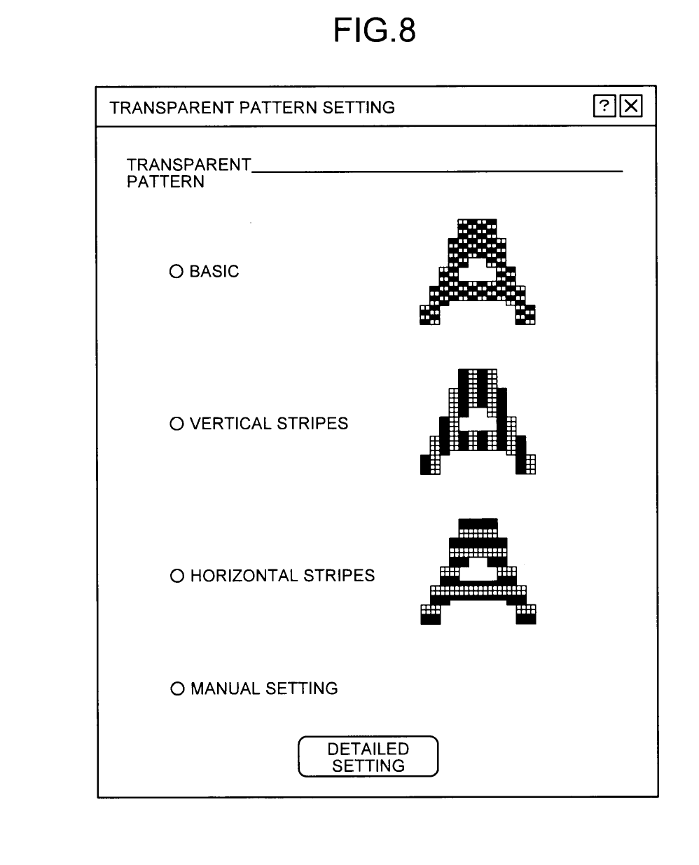

FIG. 8 is a diagram illustrating an example of a user interface for setting the transparent pattern. As illustrated in FIG. 8, four transparent patterns “Basic,” “Vertical Stripes,” “Horizontal Stripes,” and “Manual Setting” are displayed on an operation display unit (not illustrated) of the PC 100 so that the user can select one therefrom. When “Manual Setting” is selected, “Detailed Setting” for invoking a screen on which the user can freely create and define the details of the transparent pattern is also displayed so as to be selectable by the user.

If the UI unit 106a receives the user's selection “Basic,” the printer driver 106 determines the painted out part and the transparent part so that the character string “A” has a checkered pattern. If the UI unit 106a receives the user's selection “Vertical Stripes,” the printer driver 106 determines the painted out part and the transparent part so that the character string “A” has a vertical stripe pattern. If the UI unit 106a receives the user's selection “Horizontal Stripes,” the printer driver 106 determines the painted out part and the transparent part so that the character string “A” has a horizontal stripe pattern. If the UI unit 106a receives the user's selection “Manual Setting,” the printer driver 106 determines the painted out part and the transparent part so as to form a mask pattern set by the user. In this case, the printer driver 106 determines the painted out part and the transparent part in accordance with the resolution, the print data, and the like.

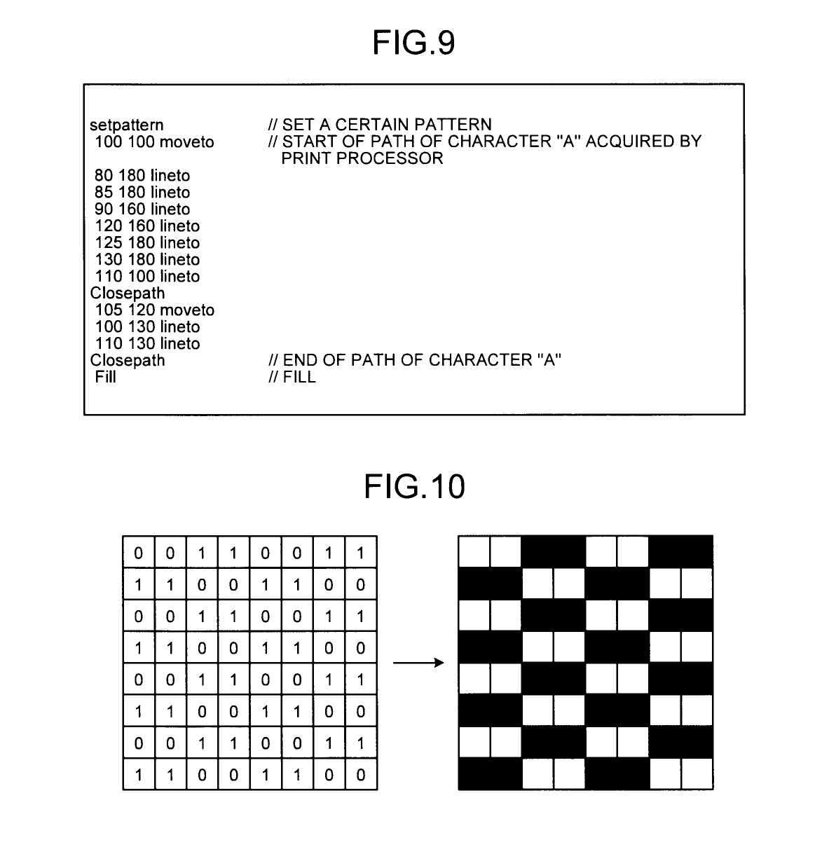

Next, the painted out part and the transparent part which are determined by the printer driver 106 in accordance with the transparent pattern of the watermark will be described for each kind of transparent pattern illustrated in FIG. 8. FIG. 9 is a diagram illustrating an example of a command transmitted from the print processor 107 to the GDI 105a. In FIG. 9, a paint-out command is designated to paint out a path specified from SetPattern to Closepath.

First, the painted out part determined by the printer driver 106 in the case that the resolution of the print data is 1200 dpi and the transparent pattern “Basic” (checkered pattern) (see FIG. 8) is selected will be described. FIG. 10 is a diagram illustrating the painted out part and the transparent part of the character string of the watermark.

In the left figure of FIG. 10, “1” represents the painted out part determined by the printer driver 106, and “0” represents the transparent part determined by the printer driver 106. In this example, the printer driver 106 determines a pattern of “1” representing the painted out part so that “0” and “1” appear every two cells in rows while “0” and “1” appear alternately in columns.

The printer driver 106 transmits the transparent pattern which is made up of the painted out part “1” and the transparent part “0” to the printer 200. The right figure of FIG. 10 illustrates the output result of the watermark from the printer 200. The printer 200 prints the watermark as illustrated in the right figure of FIG. 10 in accordance with the painted out part “1” and the transparent part “0.” In this way, the transparent pattern of the basic (checkered) pattern is formed.

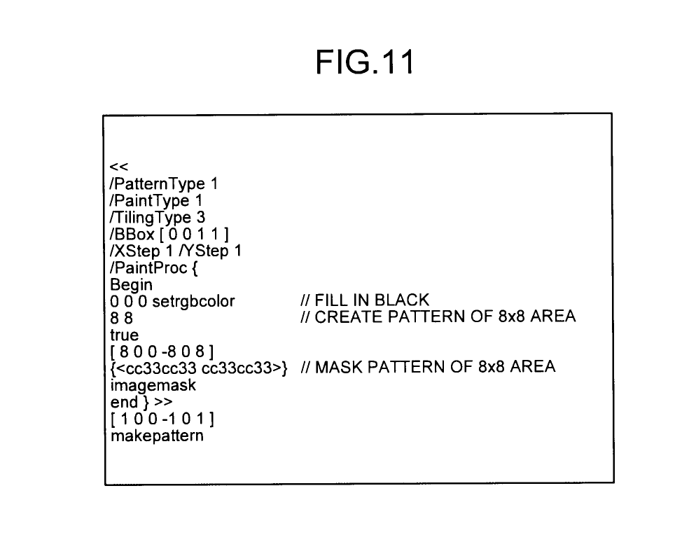

FIG. 11 is a diagram illustrating an example of a command for the mask pattern generated by the printer driver 106. In FIG. 11, for example, the printer driver 106 designates the type of the transparent pattern as “PatternTypel” and designates the size (8×8) of the painted out area with numerical values. The printer driver 106 sends the generated command to the printer 200 through the spooler 105b.

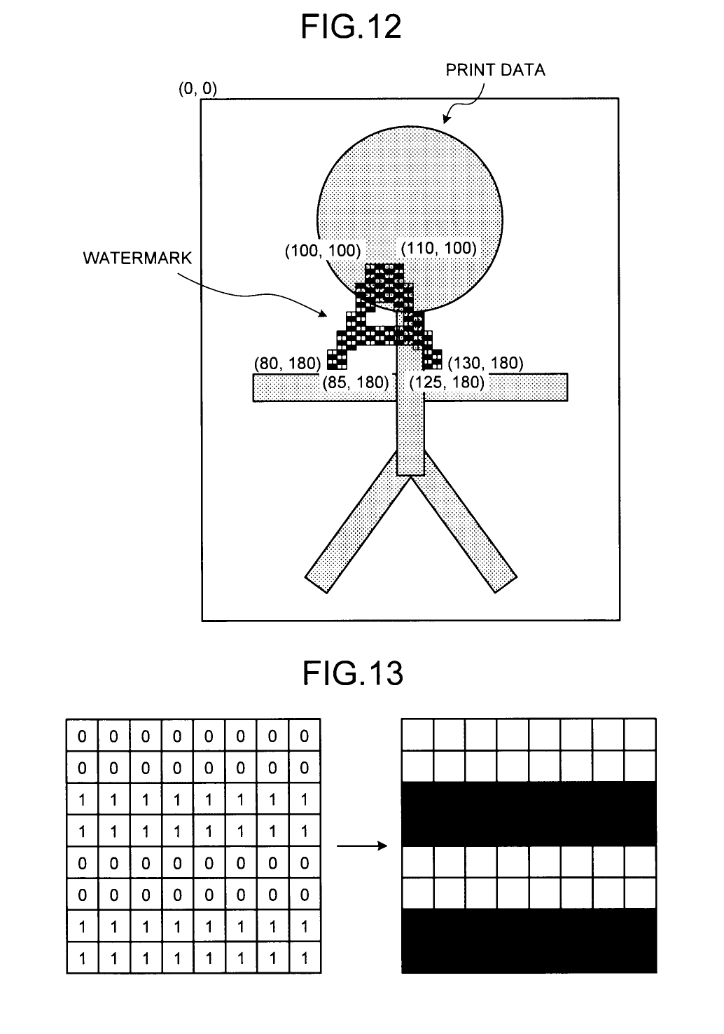

FIG. 12 is a diagram illustrating an example of the printed result by the printer 200. FIG. 12 illustrates an image of the printed result in which the character string “A” of the watermark is partially painted out. In FIG. 12, the character string “A” is generated in accordance with the coordinates (100, 100), (80, 180), (85, 180), (125, 180), (130, 180), (110, 100) which represents the paths in the character string “A” illustrated in FIG. 9.

The printer 200 prints the path of “A” generated by the print processor 107 by painting out the path on the basis of the transparent pattern illustrated in FIG. 10. In this case, although black out part which is painted out by the printer 200 do not allow the underlying print data to be visible, the remaining part which are not painted out in black allow the underlying print data to be visible. As a result, the watermark has a transparent appearance on the print data.

Next, the painted out part determined by the printer driver 106 in a case that the resolution of the print data is 600 dpi and the transparent pattern “Horizontal Stripes” (see FIG. 8) is selected will be described. FIG. 13 is a diagram illustrating a painted out parts determined by the printer driver 106. In the left figure of FIG. 13, “1” represents the painted out part determined by the printer driver 106, and “0” represents the transparent part determined by the printer driver 106. In this example, the printer driver 106 determines a pattern of “1” representing the painted out part so that the same number appears in one row while the row of “0” and the row of “1” appear alternately every two rows.

The printer driver 106 transmits the transparent pattern which is made up of the painted out part “1” and the transparent part “0” to the printer 200. The right figure of FIG. 13 illustrates the output result of the watermark by the printer 200. The printer 200 prints the watermark as illustrated in the right figure of FIG. 13 in accordance with the painted out part “1” and the transparent part “0.” In this way, the transparent pattern of the horizontal stripe pattern is formed.

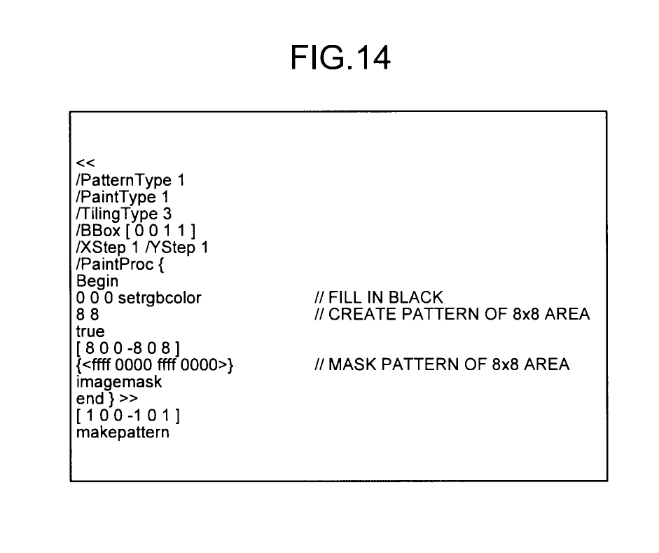

FIG. 14 is a diagram illustrating an example of a command for the mask pattern generated by the printer driver 106. In FIG. 14, for example, the printer driver 106 designates the type of the transparent pattern as “PatternTypel” and designates the size (8×8) of a painted out area with numerical values. The printer driver 106 transmits the generated command to the printer 200 through the spooler 105b.

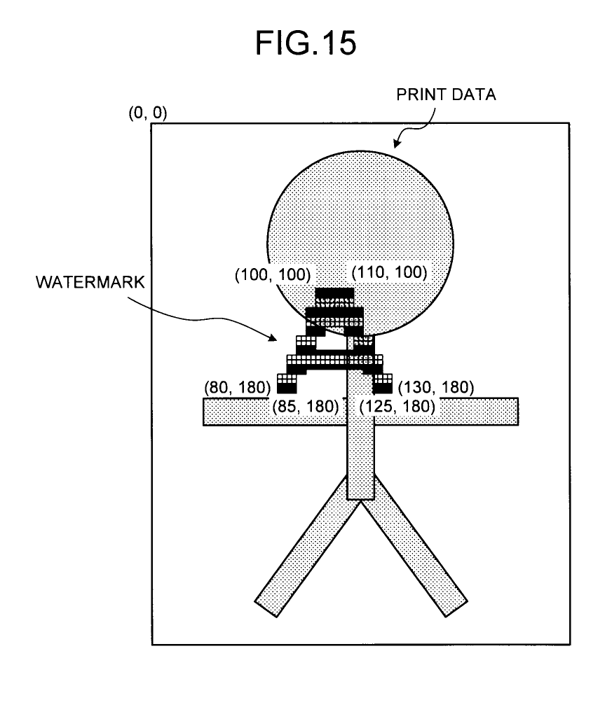

FIG. 15 is a diagram illustrating an example of the printed result from the printer 200. FIG. 15 illustrates an image of the printed result in which the character string “A” of the watermark is partially painted out. In FIG. 15, similarly to FIG. 12, the character string “A” is generated in accordance with the coordinates (100, 100), (80, 180), (85, 180), (125, 180), (130, 180), (110, 100) which is the path of the character string “A” illustrated in FIG. 11.

The printer 200 prints the path of “A” generated by the print processor 107 by painting out the path of the A on the basis of the transparent pattern (vertical stripes) illustrated in FIG. 14. In this case, although the black out part which are painted out in black by the printer 200 do not allow the underlying print data to be visible, the remaining part which are not painted out in black allow the underlying print data to be visible. As a result, the watermark has a transparent appearance on the print data.

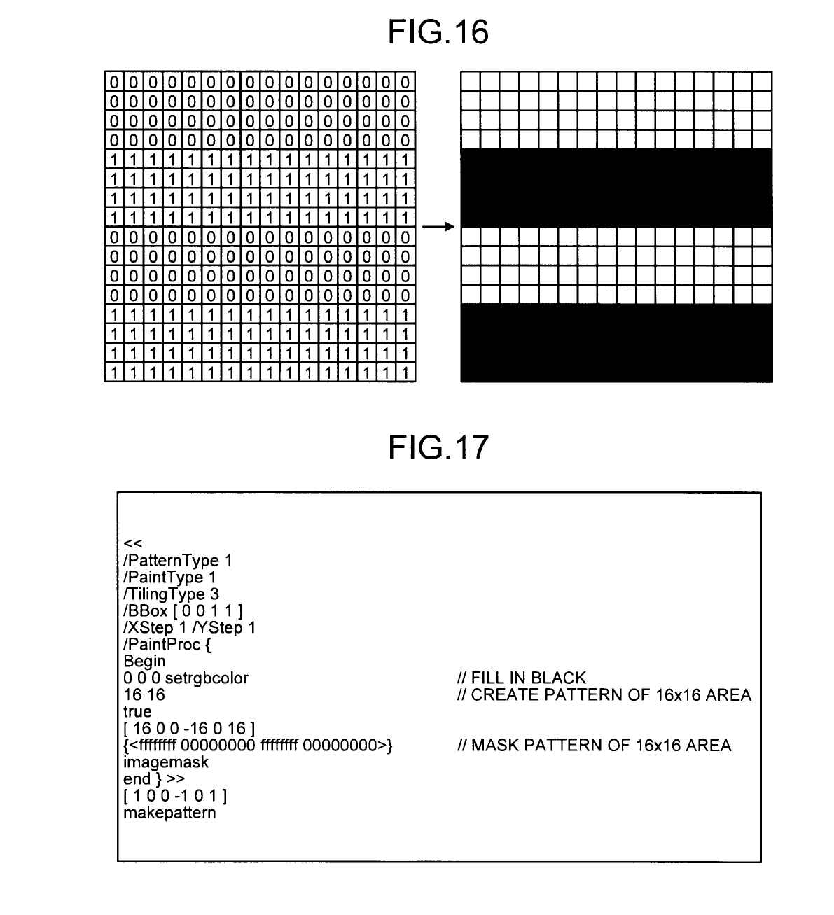

Next, the painted out part determined by the printer driver 106 in a case that the resolution of the print data is 1200 dpi and the transparent pattern “Horizontal Stripes” (see FIG. 8) is selected will be described. FIG. 16 is a diagram illustrating the painted out part determined by the printer driver 106. In the left figure of FIG. 16, “1” represents the painted out parts determined by the printer driver 106, and “0” represents the transparent part determined by the printer driver 106. In this example, the printer driver 106 determines a pattern of “1” representing the painted out part so that the same number appears in one row while the row of “0” and the row of “1” appear alternately every four rows.

The printer driver 106 transmits the transparent pattern which is made up of the painted out part “1” and the transparent part “0” to the printer 200. The right figure of FIG. 16 illustrates the output result of the watermark from the printer 200. The printer 200 prints the watermark as illustrated in the right figure of FIG. 16 in accordance with the painted out part “1” and the transparent part “0.” In this way, the transparent pattern of the horizontal stripe pattern is formed.

FIG. 17 is a diagram illustrating an example of a command for the mask pattern generated by the printer driver 106. In FIG. 17, for example, the printer driver 106 designates the type of the transparent pattern as “PatternTypel” and designates the size (16×16) of a painted out area with numerical values. The printer driver 106 transmits the generated command to the printer 200 through the spooler 105b.

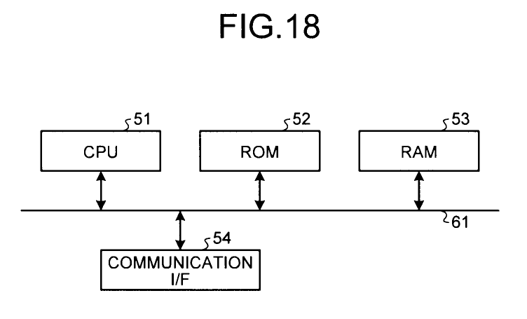

Next, a hardware configuration of the information processing device according to the present embodiment will be described with reference to FIG. 18. FIG. 18 is a diagram illustrating a hardware configuration of the information processing device according to the present embodiment.

The information processing device according to the present embodiment has a hardware configuration using a general computer which includes a control device such as a central processing unit (CPU) 51, a storage device such as a read only memory (ROM) 52 and a random access memory (RAM) 53, a communication I/F 54 that performs communication by being connected to a network, an external storage device such as a hard disk drive (HDD), a compact disc (CD) drive device, a display device such as a display, an input device such as a keyboard or a mouse, and a bus 61 that connects the respective units.

A print program executed by the information processing device according to the present embodiment is recorded in a non-transitory computer-readable recording medium, such as a Compact Disk Read Only Memory (CD-ROM), a flexible disk (FD), a Compact Disk Recordable (CD-R), or a Digital Versatile Disk (DVD), as files in an installable format or an executable format and provided as a computer program product.

Furthermore, the print program executed by the information processing device according to the present embodiment may be stored on a computer connected to a network such as the Internet and provided by being downloaded through a network. In addition, the print program executed by the information processing device according to the present embodiment may be provided or distributed through a network such as the Internet.

Furthermore, the print program according to the present embodiment may be provided in a state of being stored in advance in a ROM or the like.

The print program executed by the information processing device according to the present embodiment has a modular configuration which includes the above-described respective units (the first generation unit, the second generation unit, the output control unit, and the transceiver unit), and the CPU 51 (processor) which is an actual hardware configuration reads the print program from the recording medium and executes the print program, whereby the respective units are loaded onto the main storage device, and the respective units are generated on the main storage device.

According to the present invention, it is possible to add a watermark using a font installed in a PC to print data so that the watermark appears transparently on the print data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a first generating unit that generates a first command for instructing to paint out a character string, the character string being made of a character font stored in the device and being added to a print data;
a first transmitting unit that transmits the first command to a printer driver;
a second generating unit that, when receiving the first command, generates a second command for instructing to output the character string in a mask pattern, the mask pattern being made of a painted out part of the character string and a transparent part of the character string, the transparent part being not painted out for making the print data visible through the mask pattern; and
a second transmitting unit that transmits the first command and the second command.

2. The information processing device according to claim 1,
wherein a print setting is added to the print data, the print setting including a resolution of the print data, and
the second generating unit generates the second command for instructing to output the mask pattern which is different in accordance with the resolution included in the printing setting added to the print data.

3. The information processing device according to claim 1,
wherein the mask pattern includes a transparent pattern including the painted out part and the transparent part to constitute the character string so that the character string covers a part of the print data,
a print setting is added to the print data, the print setting including a designated transparent pattern from among a plurality of the transparent patters,
the second generating unit generates the second command for instructing to output the character string in the mask pattern, the mask pattern being for constituting the character string with the transparent pattern included in the print setting added to the print data so that the character string covers a part of the print data.

4. The information processing device according to claim 3,
wherein the transparent pattern is at least any one of a checkered pattern, a horizontal stripe pattern, or a vertical stripe pattern.

5. An information processing method comprising:
generating a first command for instructing to paint out a character string, the character string being made of a character font stored in the computer and being added to the print data;
transmitting the first command to a printer driver;
when receiving the first command, generating a second command for instructing to output the character string in a mask pattern, the mask pattern being made of a painted out part of the character string and a transparent part of the character string, the transparent part being not painted out for making the print data visible through the mask pattern; and
transmitting the first command and the second command.

6. The information processing method according to claim 5, further comprising:
adding a print setting to the print data, the print setting including a resolution of the print data, wherein
generating the second command for instructing to output the mask pattern which is different in accordance with the resolution included in the printing setting added to the print data.

7. The information processing method according to claim 5,
wherein the mask pattern includes a transparent pattern including the painted out part and the transparent part to constitute the character string so that the character string covers a part of the print data,
a print setting is added to the print data, the print setting including a designated transparent pattern from among a plurality of the transparent patters,
the generating includes generating the second command for instructing to output the character string in the mask pattern, the mask pattern being for constituting the character string with the transparent pattern included in the print setting added to the print data so that the character string covers a part of the print data.

8. The information processing method according to claim 7,
wherein the transparent pattern is at least any one of a checkered pattern, a horizontal stripe pattern, or a vertical stripe pattern.

9. A computer program product comprising a non-transitory computer-readable medium having computer-readable program codes embodied in the medium, the program codes when executed causing a computer to function as:
a drawing processor; and
a process controller for processing print data, wherein
the process controller includes:
a first generating unit that generates a first command for instructing to paint out a character string, the character string being made of a character font stored in the computer and being added to the print data; and
a first transmitting unit that transmits the first command to the drawing processor,
the drawing processor includes:
a second generating unit that, when receiving the first command, generates a second command for instructing to output the character string in a mask pattern, the mask pattern being made of a painted out part of the character string and a transparent part of the character string, the transparent part being not painted out for making the print data visible through the mask pattern; and
a second transmitting unit that transmits the first command and the second command.
